(19) United States
(12) Patent Application Publication
(10) Pub. No.: US 2026/0007271 A1
(43) Pub. Date: Jan. 8, 2026

(54) CENTRIFUGAL HOMOGENIZATION APPARATUS AND METHOD OF OPERATING THE SAME

(71) Applicant: Namawell, LLC, Costa Mesa, CA (US)

(72) Inventors: Mark Anthony Thomas, New South Wales (AU); Tibor Hegedis, New South Wales (AU); Ian James Allan, New South Wales (AU); Japhet Cordova Morabe, New South Wales (AU); Philip John Patrick Rose, New South Wales (AU); Richard Harrod, New South Wales (AU); Raymond George Corkin, New South Wales (AU)

(21) Appl. No.: 19/322,451

(22) Filed: Sep. 8, 2025

Related U.S. Application Data
(63) Continuation of application No. PCT/US2024/055499, filed on Nov. 12, 2024.
(60) Provisional application No. 63/619,533, filed on Jan. 10, 2024.

(51) Int. Cl. A47J 31/46; A47J 31/58; A47J 43/046; A47J 43/07

(52) U.S. Cl. CPC A47J 31/46; A47J 31/58; A47J 43/046; A47J 43/0761

(57) ABSTRACT

Embodiments of the present disclosure relate to food-processing apparatuses and methods of use thereof, particularly apparatuses for producing plant-based milk from plant-based products. In an exemplary embodiment, a centrifugal homogenization apparatus comprises a power base comprising a motor drive system, a control interface, and a processing device operatively coupled to the motor drive system and the control interface. In at least one embodiment, the apparatus further comprises a vessel coupled to the power base for receiving a plant-based product, the vessel comprising a lid, a filter basket, a blade cage assembly, and a nozzle assembly adapted for evacuation of liquid from the vessel.

### CROSS-REFERENCE TO RELATED APPLICATION(S)

This application is a continuation of International Application No. PCT/US2024/055499, filed Nov. 12, 2024, which claims the benefit of priority of U.S. Provisional Patent Application No. 63/619,533, filed Jan. 10, 2024, the disclosures of which are hereby incorporated by reference herein in their entireties.

### TECHNICAL FIELD

The present disclosure relates to food-processing apparatuses, and more specifically, to apparatuses adapted for extracting milk from plant-based materials.

### BACKGROUND

With a growing interest and diversity of plant-based milks, such as almond, oat, soy, rice, and coconut milks, there is an increasing demand from consumers to produce such beverages at home, in preference over commercially-produced equivalents. Advantages of home-based production include increased freshness, an understanding of the ingredients used, personal health benefits, and cost savings by not purchasing commercial plant-based milks.

A variety of electric and non-electric methods are well known in the domestic production of plant-based milks. Devices adapted for these purposes typically function by straining pre-processed ingredients through a filter. Processing is typically performed at high speeds, reducing particle size and improving incorporation of solid ingredients into the liquid.

Domestic appliances designed for producing plant-based milks include blenders and juicers. Because these appliances are not primarily designed for the production of plant-based milks, they are generally inefficient in processing ingredients. Blenders initially process the ingredients, and then the user strains ingredients using a secondary device, such as a straining bag or filter membrane. Solids particles would otherwise to be too large, producing a beverage with an undesirable mouthfeel. Domestic juicers incorporate both processing components and a filter wall, however, this method of plant-based milk production produces an inefficient incorporation of solids and liquids with much of the solid material being retained by the appliance, resulting in a watery consistency.

Another approach commonly used for the production of soy milk includes a processing blade positioned within a void created by a filter mesh, both submerged in liquid and combined with the application of heat. Pressure produced by processing solids within the mesh void forces ingredients through the filter to retain the undesired larger particles.

There are various disadvantages of using current domestic appliances for the production of plant-based milks. These include, but are not limited to, the number of tools required, time to achieve a palatable plant-based milk, efficiency of the incorporation of ingredients, and a high degree of cleaning required to produce contaminant-free milk.

### SUMMARY

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

One aspect of the present disclosure relates to a method of operating a centrifugal homogenization apparatus. In at least one embodiment, the method comprises: causing the apparatus to perform a first stage operation to blend a plant-based product together with a liquid within a single vessel for a first time duration; and responsive to determining that the vessel is substantially free of liquid, causing the apparatus to perform a second stage operation to centrifuge residual plant-based product within the vessel for a second time duration.

In at least one embodiment, causing the apparatus to perform the first stage operation occurs responsive to determining that a lid and a nozzle assembly of the apparatus are in a closed state.

In at least one embodiment, determining that the vessel is substantially free of liquid comprises detecting a sensor element disposed within the nozzle assembly to determine that the nozzle assembly is in an open state for a third time duration after the first time duration has expired.

In at least one embodiment, the method further comprises: causing the nozzle assembly to open to drain the vessel of the liquid after expiration of the first time duration. In at least one embodiment, the sensor element comprises a Hall effect sensor.

In at least one embodiment, the first stage operation is associated with rotation in a first direction. In at least one embodiment, the second stage operation is associated with rotation in a second direction, where the second direction opposed to the first direction.

In at least one embodiment, determining that the vessel is substantially free of liquid comprises receiving a user confirmation via a control interface of the apparatus.

In at least one embodiment, determining that the vessel is substantially free of liquid comprises detecting, after expiration of the first time duration, that a mass contained in the vessel has decreased below a mass threshold.

A further aspect relates to a method of extracting a liquid substance from a plant-based product. In at least one embodiment, the method comprises: loading a measured amount of the plant-based product into a vessel of a centrifugal homogenization apparatus; determining that both a lid and a nozzle of the apparatus are in a closed state to enable a motor drive system of the apparatus; responsive to the determination, initiating a first stage operation, the first stage operation engaging the motor drive system to blend the plant-based product in the vessel for a first time duration; evacuating liquid from the vessel; subsequently initiating a second stage operation, the second stage operation engaging the motor drive system to centrifuge residual plant-based product in the vessel for a second time duration; and completing collection of the liquid from the centrifuged residual plant-based product.

In at least one embodiment, the liquid is evacuated when the nozzle of the apparatus is opened after completion of the first stage operation.

In at least one embodiment, the liquid is evacuated into an accessory container positioned at the nozzle opening.

In at least one embodiment, the motor drive system is configured to independently control rotation of a blender blade during the first stage operation and counter-rotation of a filter mesh during the second stage operation.

In at least one embodiment, each of the first time duration and the second time duration is from about 10 seconds to about 120 seconds.

In at least one embodiment, the plant-based product is selected from almonds, hazelnuts, cashews, flaxseeds, walnuts, tiger nuts, quinoa, chia seeds, macadamia nuts, soy beans, oats, rice, coconut, potatoes, hemp seeds, peas, or a combination thereof.

A further aspect relates to a centrifugal homogenization apparatus that is configured to perform the method of any of the preceding embodiments.

A further aspect relates to a centrifugal homogenization apparatus. In at least one embodiment, the apparatus comprises: a power base comprising a motor drive system, a control interface, and a processing device operatively coupled to the motor drive system and the control interface; a vessel coupled to the power base for receiving a plant-based product, the vessel comprising a lid, a filter basket, a blade cage assembly, and a nozzle assembly adapted for evacuation of liquid from the vessel; and an interlock system configured to determine an open state and closed state for each of the lid and the nozzle assembly.

In at least one embodiment, the control interface comprises an actuatable control for operating the power base and a display device. In at least one embodiment, the actuatable control allows for selection of an operation mode. In at least one embodiment, the display device is configured to display the selected operation mode. In at least one embodiment, a time of operation is displayed on the display device when the selected operation mode is initiated. In at least one embodiment, the operation mode corresponds to one of a plurality of options for selecting a plant-based product. In at least one embodiment, each of the options is associated with a blending time duration, a centrifuging time duration, a blending speed, and a centrifuging speed.

In at least one embodiment, the lid comprises a bayonet-style coupling to the vessel.

In at least one embodiment, the lid comprises a hinged-style coupling to the vessel.

In at least one embodiment, the interlock system is provided via one or more Hall effect sensors integrated into one or more of the lid or the nozzle assembly.

In at least one embodiment, the apparatus further comprises at least one load cell disposed on a supporting portion of the power base and operatively coupled to the processing device. In at least one embodiment, the processing device is configured to monitor a mass of contents contained in the vessel.

A further aspect relates to an assembly for insertion into a vessel of a centrifugal homogenization apparatus. In at least one embodiment, the assembly comprises: a blade cage assembly comprising a funneled upper portion connected to a lower base portion via a plurality of ribs disposed around an outer periphery, and a blender blade rotatably coupled to the lower base portion; and a filter basket comprising a filter mesh body and a basket base. In at least one embodiment, the blade cage assembly is nested within the filter basket such that the lower base portion is seated in the basket base.

In at least one embodiment, the plurality of ribs are configured to agitate contents of the vessel during operation of the centrifugal homogenization apparatus.

In at least one embodiment, the plurality of ribs are configured for use as scrapers to dislodge pulp accumulated along an interior surface of the filter basket during removal of the blade cage assembly from the filter basket.

In at least one embodiment, the plurality of ribs are constructed such that the plurality of ribs cause the outer diameter of blade cage assembly to be greater than the inner diameter of the filter mesh body at locations where the plurality of ribs contact the filter mesh body such that the plurality of ribs fit tightly against an interior surface of the filter mesh body and prevent slippage between the blade cage assembly and the filter basket during operation of the centrifugal homogenization apparatus.

In at least one embodiment, the filter mesh body comprises mesh openings of about 0.1 mm to about 0.3 mm in diameter.

In at least one embodiment, the lower base portion comprises a plurality of openings covered by a lower filter mesh to facilitate liquid circulation and improved mixing during operation of the centrifugal homogenization apparatus.

In at least one embodiment, the funneled upper portion comprises a central spindle extending distally therefrom. In at least one embodiment, the central spindle is configured to engage with a lid of the vessel.

In at least one embodiment, the vessel further comprises a one-way bearing assembly configured to enable independent rotation of the filter basket and the blender blade in opposite directions when coupled to a motor drive system of the centrifugal homogenization apparatus.

### BRIEF DESCRIPTION OF THE DRAWINGS

The present disclosure is illustrated by way of example, and not by way of limitation, in the figures of the accompanying drawings, in which:

FIG. 1A illustrates a front perspective view of an exemplary centrifugal homogenization apparatus, in accordance with at least one embodiment;

FIG. 1B illustrates a rear perspective view of the exemplary centrifugal homogenization apparatus, in accordance with at least one embodiment;

FIG. 1C illustrates a front view of the exemplary centrifugal homogenization apparatus, in accordance with at least one embodiment;

FIG. 1D illustrates a right side view of the exemplary centrifugal homogenization apparatus, in accordance with at least one embodiment;

FIG. 1E illustrates a left side view of the exemplary centrifugal homogenization apparatus, in accordance with at least one embodiment;

FIG. 1F illustrates a rear view of the exemplary centrifugal homogenization apparatus, in accordance with at least one embodiment;

FIG. 1G illustrates a top view of the exemplary centrifugal homogenization apparatus, in accordance with at least one embodiment;

FIG. 2 illustrates an exploded view of an exemplary vessel for use in a centrifugal homogenization apparatus, in accordance with at least one embodiment;

FIG. 3A illustrates an exemplary filter basket, in accordance with at least one embodiment;

FIG. 3B illustrates an exploded view of an exemplary basket base and an exemplary base mesh of the exemplary filter basket, in accordance with at least one embodiment;

FIG. 3C illustrates a cutaway view of the filter basket showing the position of the base mesh within the basket base, in accordance with at least one embodiment;

FIG. 4A illustrates a perspective view of an exemplary blade cage assembly, in accordance with at least one embodiment;

FIG. 4B illustrates a side view of the exemplary blade cage assembly, in accordance with at least one embodiment;

FIG. 4C illustrates a top view of the exemplary blade cage assembly, in accordance with at least one embodiment;

FIG. 4D illustrates an exploded view of the exemplary blade cage assembly, in accordance with at least one embodiment;

FIG. 5A illustrates a cutaway view of the vessel, in accordance with at least one embodiment;

FIG. 5B illustrates an exploded view of the basket drive assembly, in accordance with at least one embodiment;

FIG. 5C illustrates a cutaway view of the basket drive assembly, in accordance with at least one embodiment;

FIG. 5D illustrates a cutaway view of the vessel illustrating the blade cage assembly nested within the filter basket and inserted within the vessel body, in accordance with at least one embodiment;

FIG. 5E illustrates a cutaway view of an alternative vessel, in accordance with at least one embodiment;

FIG. 6 illustrates a cutaway view of a power base, in accordance with at least one embodiment;

FIG. 7 illustrates the coupling of various drive components, in accordance with at least one embodiment; and

FIG. 8 illustrates a flow diagram for an exemplary method of operating a centrifugal homogenization apparatus, in accordance with at least one embodiment.

### DETAILED DESCRIPTION

Described herein are apparatuses and methods of using the same for producing plant-based milk food-processing. Various embodiments relate specifically to a centrifugal homogenization apparatus that utilizes a combination of processing via a blade assembly for reducing food particle size, evacuation of the liquid via an outlet, and centrifugal displacement via a rotating filter basket to evacuate remaining liquid in the vessel. Both the blade assembly and the filter basket are located within the same processing vessel and share a common drive coupling assembly in communication with a single motor.

For example, in certain embodiments, the centrifugal homogenization apparatus includes a power base with a motor drive system that is configured to independently drive a blender blade and a centrifugal filter body. The power base can also include a control interface that allows a user to adjust speed and time parameters, select a recipe, adjust parameters of a recipe, or provide other inputs. An on-board processing device may be operatively coupled to the motor drive system and control interface. The apparatus can further include a vessel that can couple to the power base, and is configured to hold a plant-based product and liquid. In at least one embodiment, the vessel includes a lid, a filter basket, a blade cage assembly, and a nozzle assembly adapted for evacuating liquid from the vessel. In at least one embodiment, an the apparatus includes one or more interlock systems that are operatively coupled to the processing device of the power base, which allows the processing device to determine whether the lid and/or the nozzle assembly are in an open state or a closed state, such that the processing device can avoid powering the motor drive system at points in which one or more of these components are in an open state.

The embodiments described herein provide for an apparatus capable of blending and centrifuging liquids and solids to produce improved homogenized beverages and emulsions. In at least one embodiment, a concentrically-aligned blade and filter basket arrangement is removably located within a sealed vessel, which is in separable communication with a power base. The sealed vessel includes an outlet (e.g., a nozzle) and a lid, each of which may be equipped with a sensor for determining whether the component is opened or closed.

In at least one embodiment, the vessel may further include a pouring spout and a handle to facilitate pouring out the contents of the vessel. In such embodiments, for example, the user may be prompted to pour out the contents of the vessel as a step during a process recipe (e.g., between blending and centrifugation operations).

An exemplary operation method is now described. First, solid and liquid ingredients are added into the vessel containing the filter basket and blade cage assembly when the outlet is closed and the lid is open. The lid is then fitted to the vessel to seal the vessel prior to commencing a first stage operation. During the first stage operation, blades within the vessel process the liquid and solids at high speed to reduce the particle size of the solids and homogenize the ingredients, while a filter basket within the vessel remains substantially stationary. The blended liquid and solids are then evacuated via the outlet of the vessel after the first stage operation is completed and before the second stage operation begins. For example, the apparatus may be equipped with one or more sensors for determining whether liquid has been substantially evacuated from the vessel. The second stage operation begins where the filter basket rotates at a reduced speed and in an opposing direction compared to the blade during the first stage operation, while the outlet of the vessel remains open. The rotation of the filter basket applies a centrifugal force that separates larger-than-preferred solids (based on a fixed opening size of the filter mesh) from the liquid in the vessel, while residual liquid is evacuated.

A two-stage operation provides the advantage of food processing to the desired food particle size with a measured separation of solids from liquid via a filter mesh, controlling solid particle size in solution and thus providing a consistent mouthfeel and viscosity during consumption. Certain embodiments utilize a bi-directional configuration to rotate the blade and filter basket in opposite directions. Independent operation of the blade and filter basket provides a more mechanically efficient approach compared to a configuration for which the blade and filter basket operate in the same direction. For example, while such an approach could implement a clutch configuration, this could also require manually decoupling both the blade and filter basket so that they do not operate simultaneously, and present problems to sealing these components to avoid leakage of liquid outside of the vessel. Moreover, in a configuration where the blade and filter basket rotate in the same direction simultaneously, this can result in solid material adhering the interior of the filter basket due to the centrifugal force without being processed by the blade.

The embodiments of the present disclosure provide, but are not limited to, the following advantages: (1) reduced user intervention during the production of plant-based product processing; (2) reduced overall processing time; (3) improved and consistent incorporation of solids into liquid to improve the overall quality of the homogenized plant-based product; and (4) reduced cleaning time.

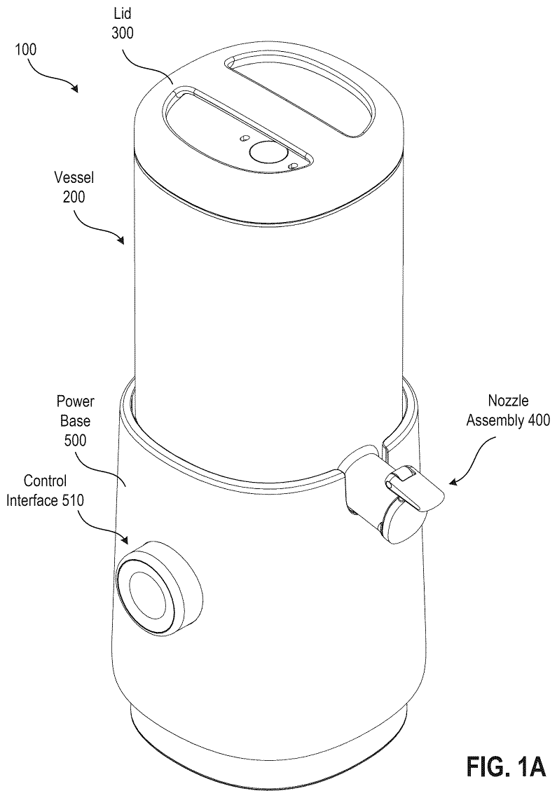

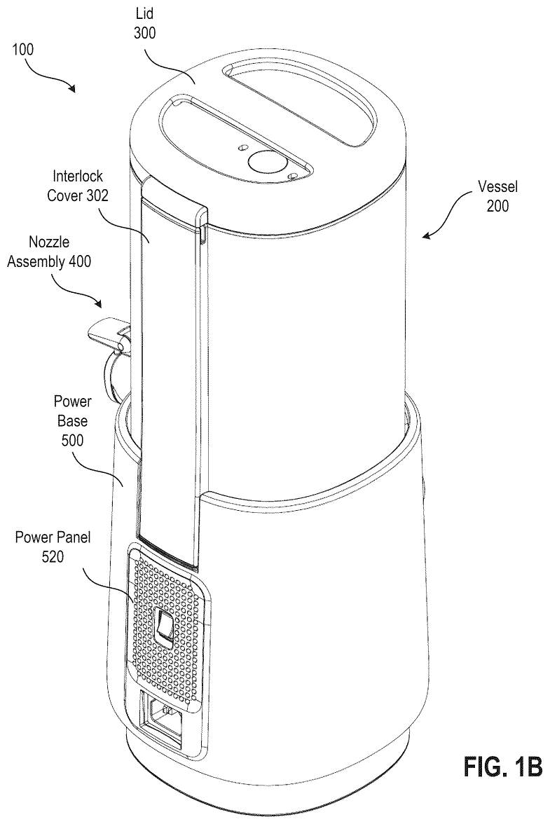

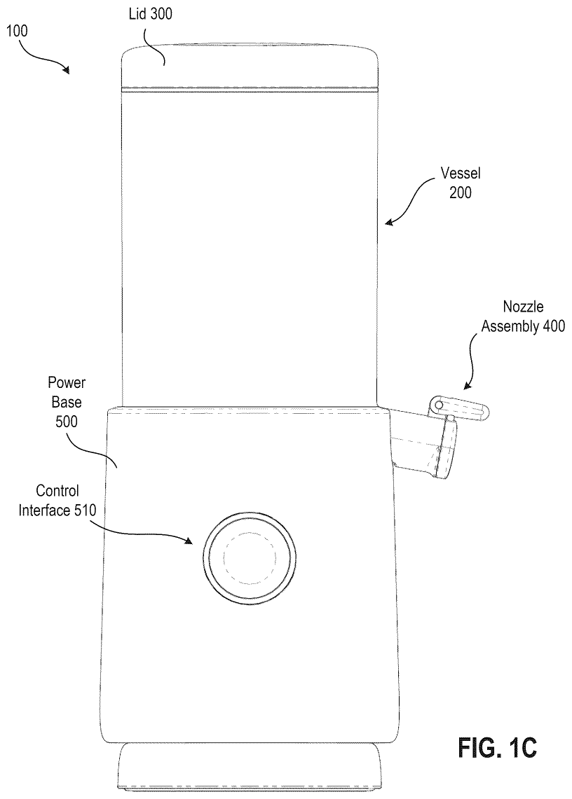

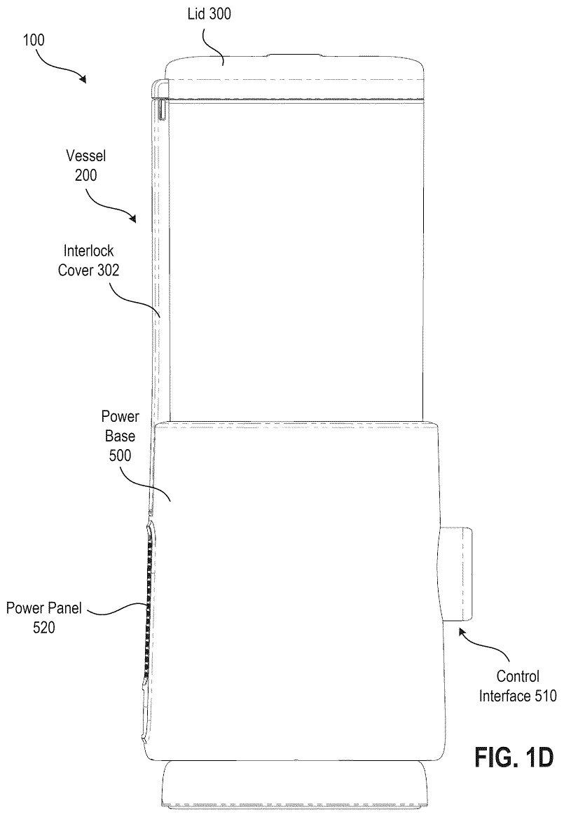

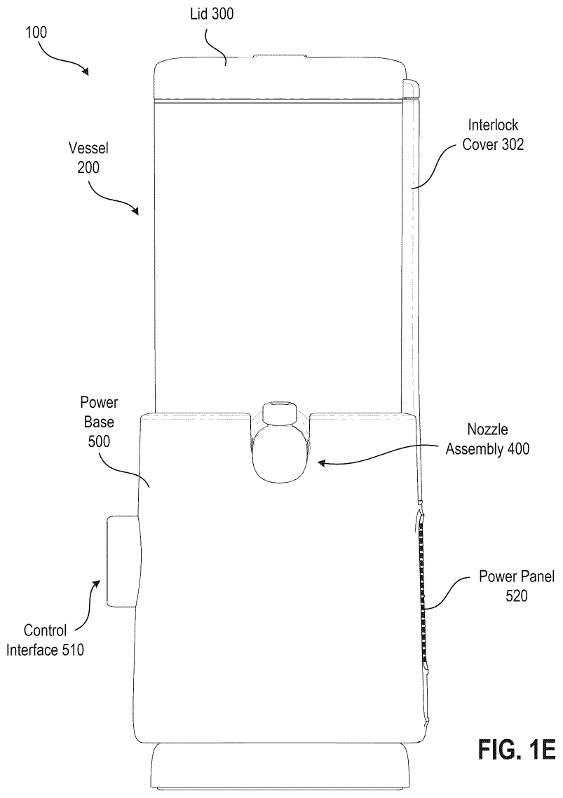

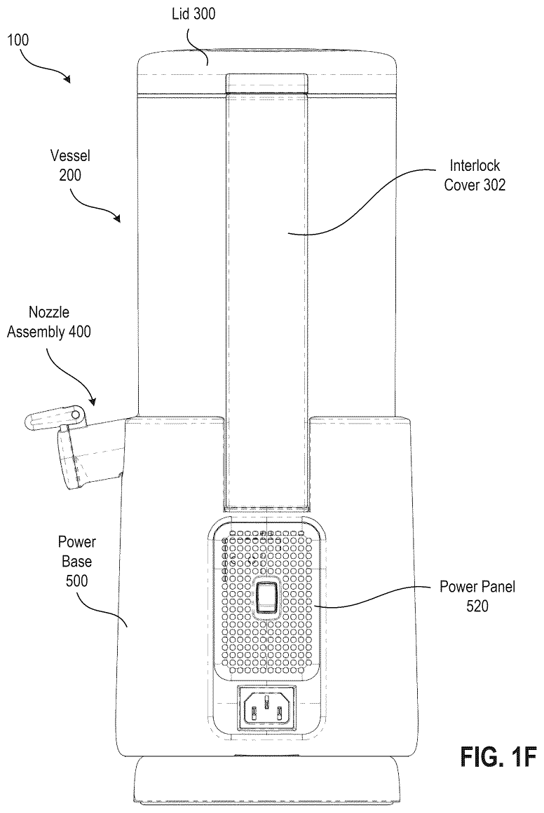

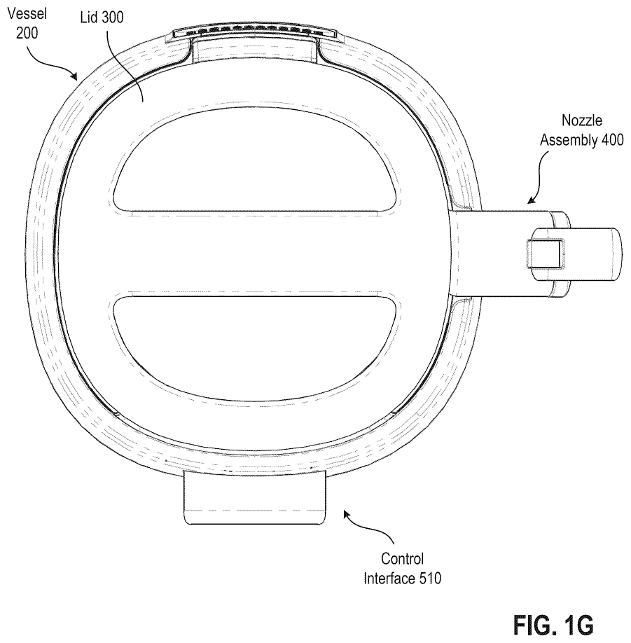

FIGS. 1A and 1B illustrate, respectively, front and rear perspective views of an exemplary centrifugal homogenization apparatus 100, in accordance with at least one embodiment. The apparatus 100 includes a vessel 200 that is coupled to a power base 500. The vessel 200 is adapted for receiving a plant-based product within its interior volume, and comprises a lid 300, a filter basket 220 (not visible in FIGS. 1A-1G), a blade cage assembly 240 (not visible in FIGS. 1A-1G), and a nozzle assembly 400 adapted for evacuation of liquid from the vessel. In at least one embodiment, the apparatus 100 comprises one or more interlock systems, which may be operatively coupled to/controlled by a processing device within the power base 500, for determining an open state and a closed state for each of the lid 300 and the nozzle assembly 400 during operation of the apparatus 100. In at least one embodiment, the vessel 200 comprises an interlock cover 302 that is used to facilitate and stabilize coupling of the lid 300 to the vessel 200 and the vessel 200 to the power base 500. In at least one embodiment, the power base 500 includes a control interface 510 that allows for a user to control various operational parameters of the apparatus 100.

FIGS. 1C-1G illustrate various other views of the apparatus 100, including a front view (FIG. 1C), a right side view (FIG. 1D), a left side view (FIG. 1E), a rear view (FIG. 1F), and a top view (FIG. 1G).

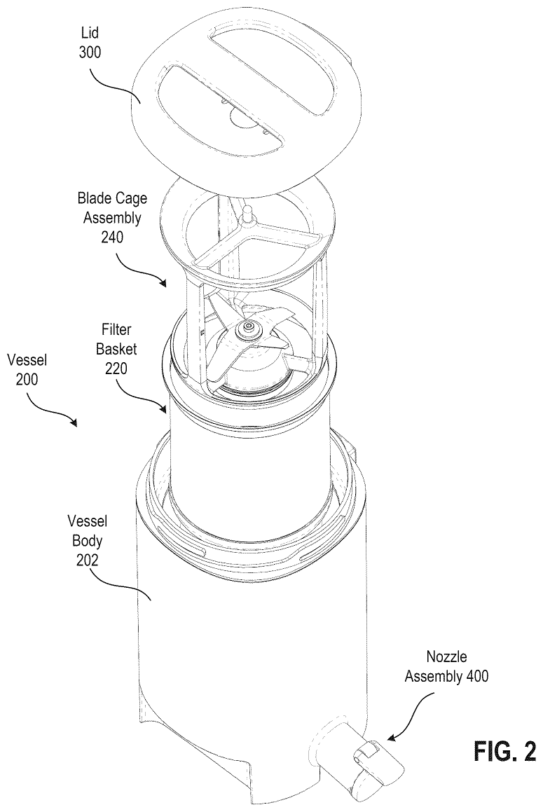

FIG. 2 illustrates an exploded view of the vessel 200 revealing the internal components of the vessel 200, in accordance with at least one embodiment. The components include a blade cage assembly 240 and a filter basket 220, which are arranged in a nested configuration and housed within the vessel body 202. The blade cage assembly 240 fits within the filter basket 220, and can then be inserted together into the vessel body 202. The lid 300 is adapted to cover and seal the filter basket 220 and the blade cage assembly 240 within the vessel 200, as illustrated in FIGS. 1A-1G. In at least one embodiment, the lid 300 couples to the vessel body 202 via a bayonet-style coupling. In at least one other embodiment, the lid 300 couples to the vessel body 202 via a hinged-style coupling.

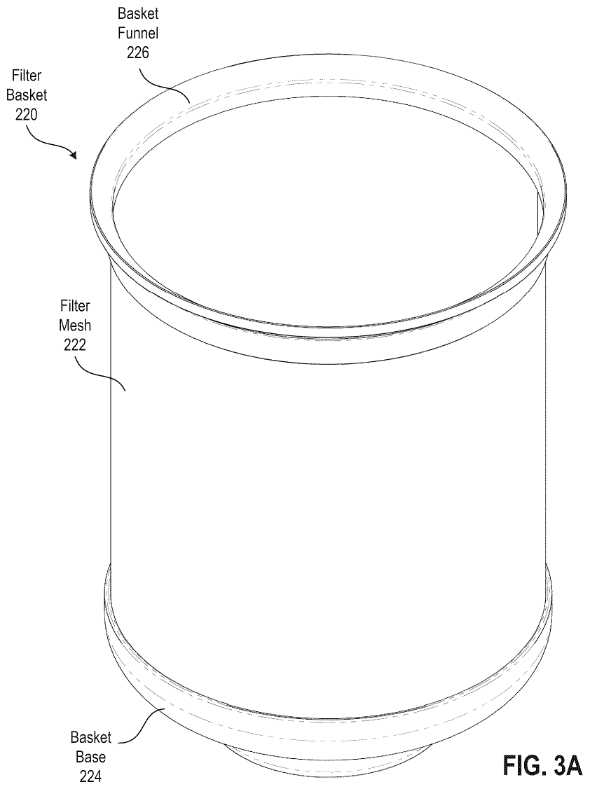

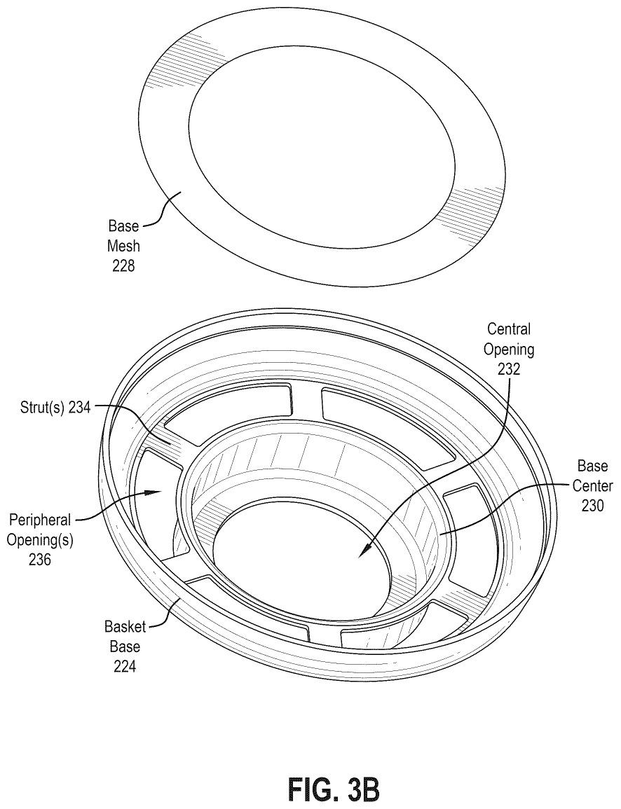

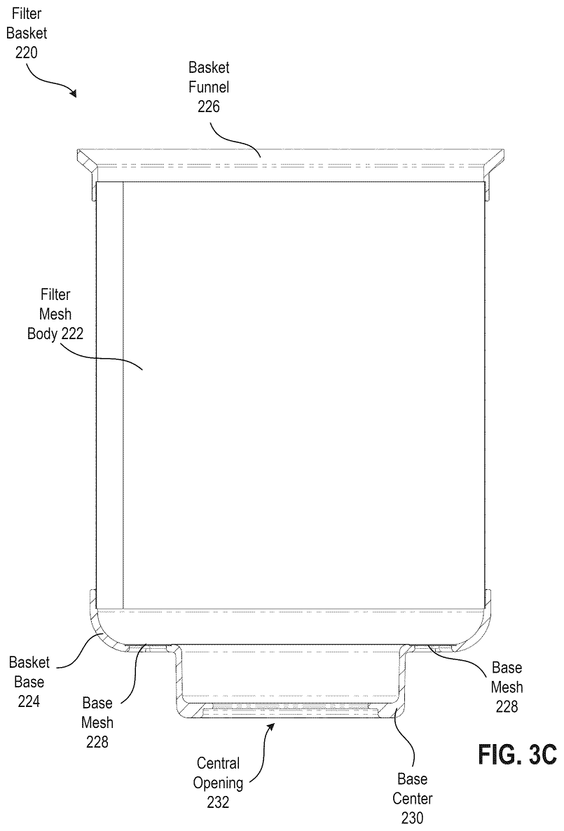

FIG. 3A illustrates the filter basket 220 in accordance with at least one embodiment. The filter basket 220 includes a cylindrical filter mesh body 222, a basket funnel 226 coupled to a first perimeter edge of the filter mesh body 222, and a basket base 224 coupled to a second opposing perimeter edge of the filter mesh body 222. In at least one embodiment, one or more of the basket base 224 or the basket funnel 226 are formed from a rigid material, such as a rigid polymeric material or a metal. In at least one embodiment, a wall thickness and mesh openings of the filter mesh body 222 are selected to provide adequate filtration of solids while providing sufficient structural support to the filter basket 220. For example, the average size of mesh openings may range from about 0.1 mm to about 0.3 mm in diameter.

In at least one embodiment, the filter basket 220 is interchangeable with other types of filter baskets depending on the ingredient processing requirements. Different mesh opening sizes may be selected depending on the consistency of the food product. For beverages where minimal texture is desirable, a filter basket with smaller filter openings would be appropriate. For alternative cases, where a thicker ingredient consistency is preferred, such as a puree, coulis, or thick sauce, a filter basket with a larger filter openings may be assembled together with the blade cage assembly 240. For other conditions, where only blending is required, the appliance may also be operated with no filter basket 220.

The filter mesh body 222 of the filter basket 220 can comprise, but are not limited to, the following materials: laser- or chemically-etched stainless steel, woven stainless steel, expanded stainless steel, or a nylon plastic mesh. Each filter material type and manufacturing process can influence the ingredient texture and viscosity via the unique geometry of the filter mesh body 222, and can thus be more suitable for specific ingredient applications.

FIG. 3B illustrates an exploded view of the basket base 224 and a base mesh 228 that is secured within the basket base 224, in accordance with at least one embodiment. As illustrated, the basket base 224 is designed to seat the blade cage assembly 240, and includes a base center 230 having a central opening 232 formed therethrough to allow for components of the blade cage assembly 240 to couple to a motor drive system 550 of the power base 500. In at least one embodiment, the base center 230 is cup-shaped and is supported within the center of the basket base 224 by a plurality of struts 234. In at least one embodiment, the struts 234 define a plurality of peripheral openings 236. In at least one embodiment, the base mesh 228 is seated above the peripheral openings 236. The arrangement of the base mesh 228 and peripheral openings 236 facilitate liquid circulation and improved mixing at the bottom of the vessel 200 during blending and centrifugation operations compared to a basket base 224 having no peripheral openings 236 or base mesh 228.

FIG. 3C illustrates a cutaway view of the filter basket 220 showing the position of the base mesh 228 within the basket base 224.

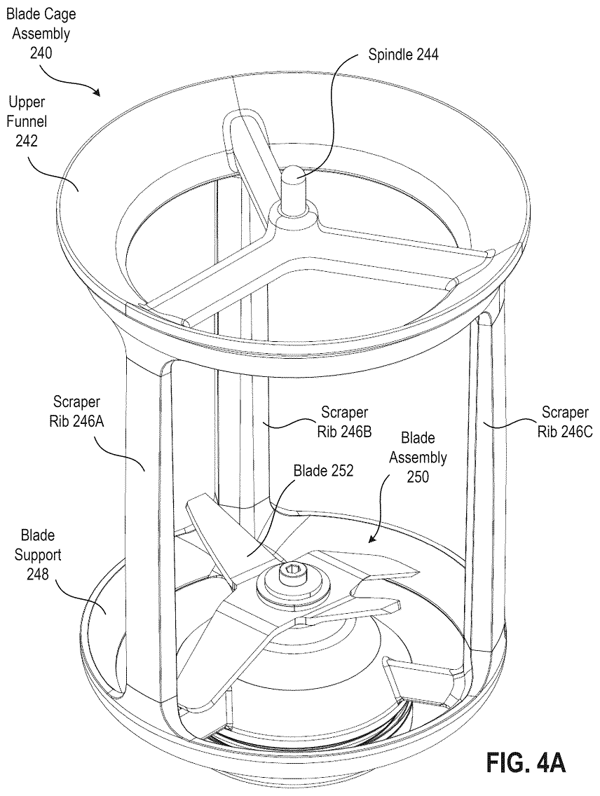

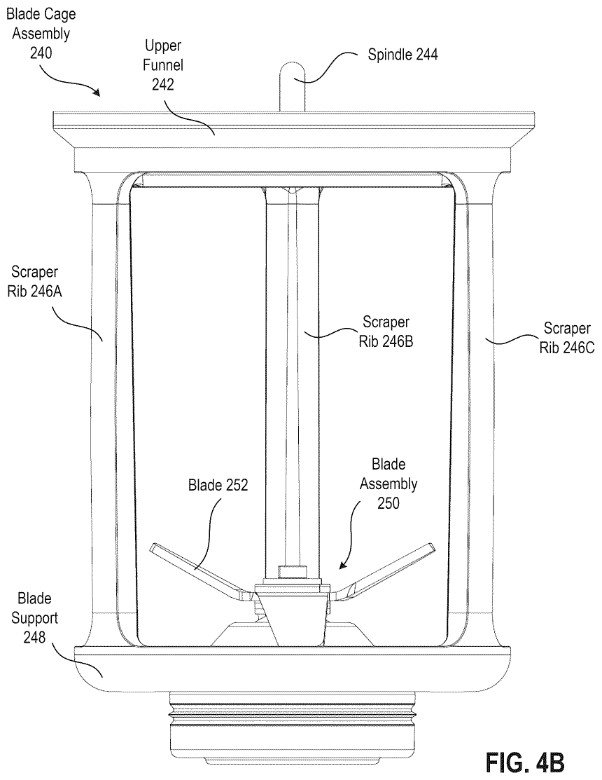

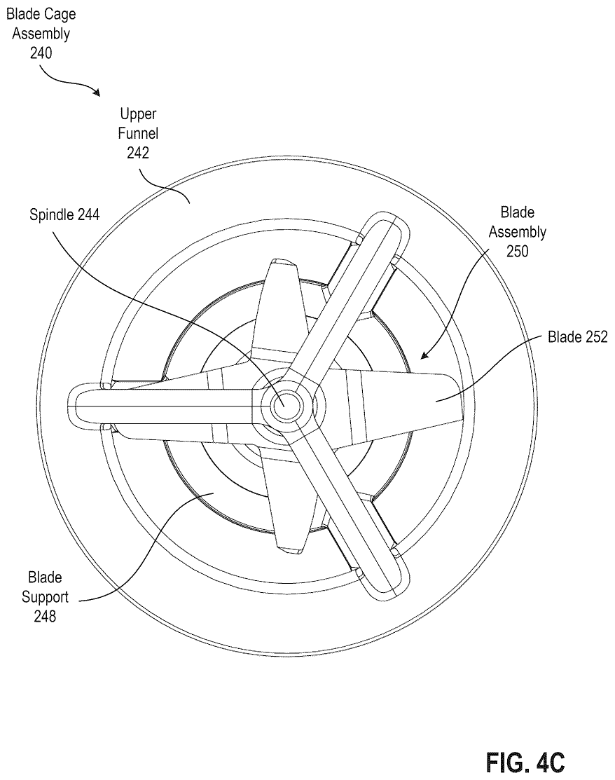

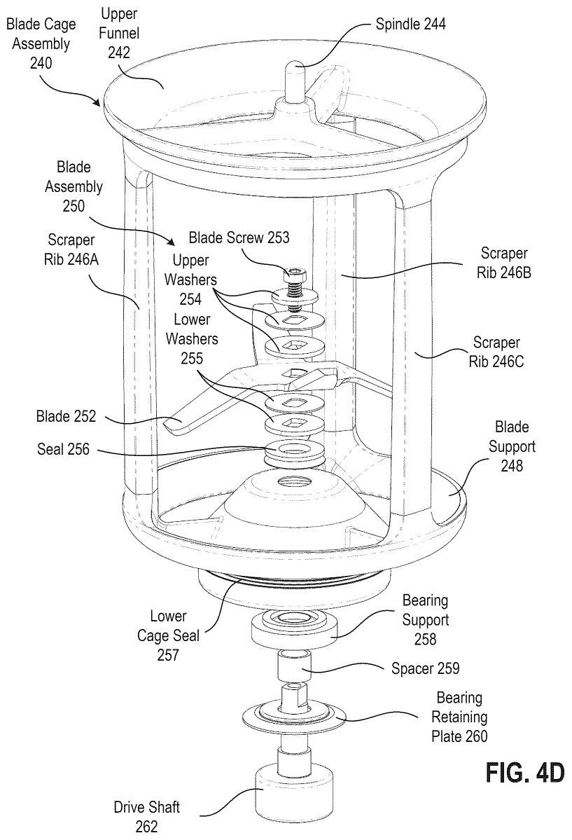

FIGS. 4A-4D illustrate various other views of the blade cage assembly 240, including a perspective view (FIG. 4A), a side view (FIG. 4B), a top view (FIG. 4C), and an exploded view (FIG. 4D).

As shown, the blade cage assembly 240 includes an upper funnel 242, a blade support 248, and a plurality of scraper ribs 246A-246C that connect the upper funnel 242 and the blade support 248. The blade cage assembly 240 is designed to fit firmly within the filter basket 220. In at least one embodiment, the scraper ribs 246A-246C are constructed with a maximum outer surface radius dimension greater than the inner diameter of the filter mesh body 222 and to prevent slippage between the blade cage assembly 240 and the filter basket 220 during operation of the apparatus. In at least one embodiment, during operation of the apparatus, the scraper ribs 246A-246C are configured to agitate contents of the vessel 200 by creating turbulent flow inside of the filter mesh body 222. In at least one embodiment, the scraper ribs 246A-246C are configured for use as scrapers to dislodge pulp that has accumulated along an interior surface of the filter mesh body 222 during removal of the blade cage assembly 240 from the filter basket 220. For example, as the user removes the blade cage assembly 240 from the filter basket 220, the user may rotate the blade cage assembly 240 as they pull it from the filter basket 220, causing the scraper ribs 246A-246C to scrape and dislodge the pulp to facilitate cleaning.

In at least one embodiment, the upper funnel 242 is shaped to create a near continuous funnel shape together with the basket funnel 226 when the blade cage assembly 240 is inserted into the filter basket 220. In at least one embodiment, the upper funnel 242 further includes a central spindle 244 that extends distally from the upper funnel 242. In at least one embodiment, the central spindle 244 is secured within a recess of the lid 300 when the vessel 200 is assembled and the lid is coupled thereto, which increases the stability of the blade cage assembly 240 during operation of the apparatus 100.

In at least one embodiment, a blade assembly 250 is coupled to the blade support 248. As illustrated in the exploded view of FIG. 4D, the blade assembly 250 includes a blade 252 that is secured to the blade support 248 by a blade screw 253. The blade 252 may be flanked on each side by a plurality of upper washers 254 and lower washers 255. In at least one embodiment, a seal 256 is disposed between the lower washers 255 and the blade support 248. A lower cage seal 257 may surround a lower portion of the blade support 248 to prevent liquid leakage out of the vessel 200 when the blade cage assembly 240 is nested therein. Ball bearings may be secured between a bearing support 258 and a bearing retaining plate 260, which are separated by a spacer 259 placed around an upper portion of a drive shaft 262. The blade screw 253 couples to the upper portion of the drive shaft 262 to secure the entire blade assembly 250 to the blade support 248.

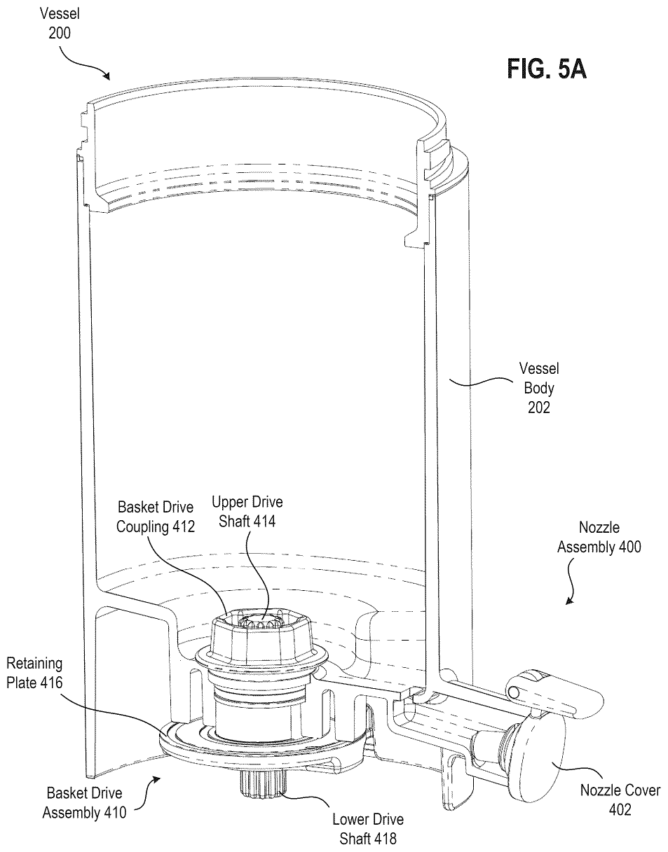

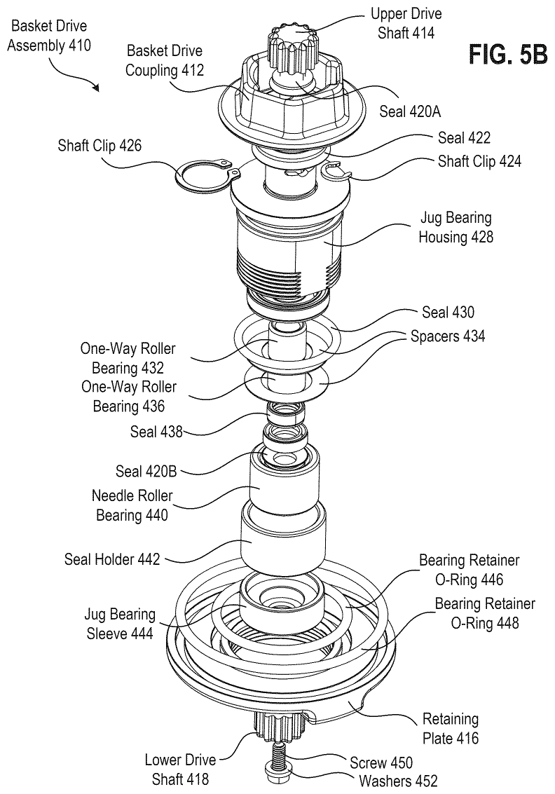

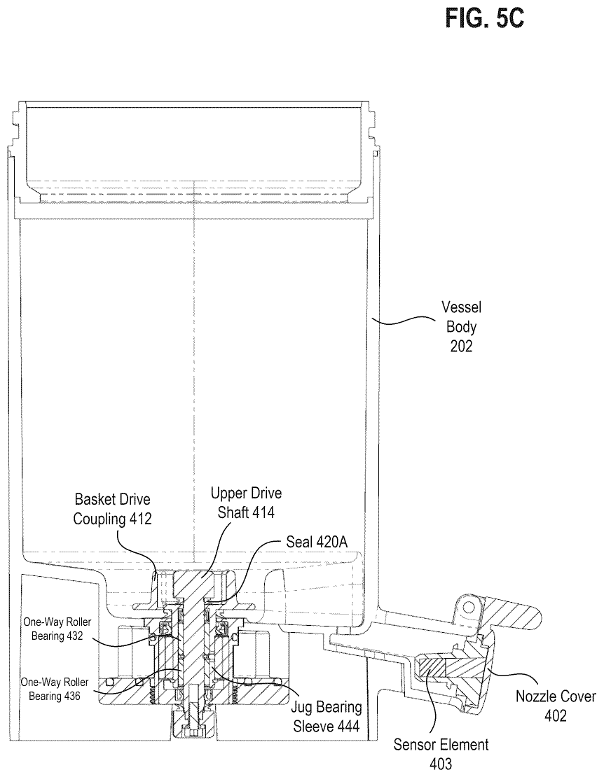

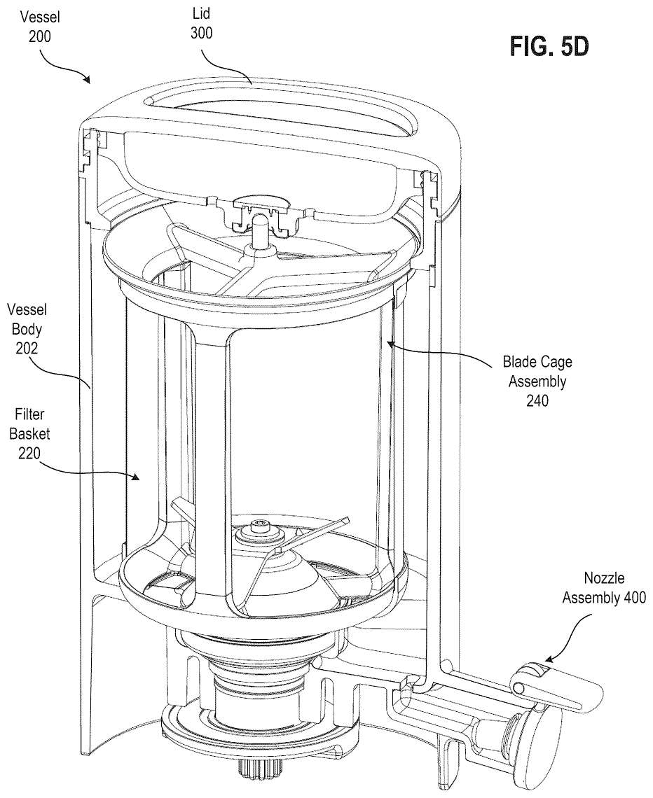

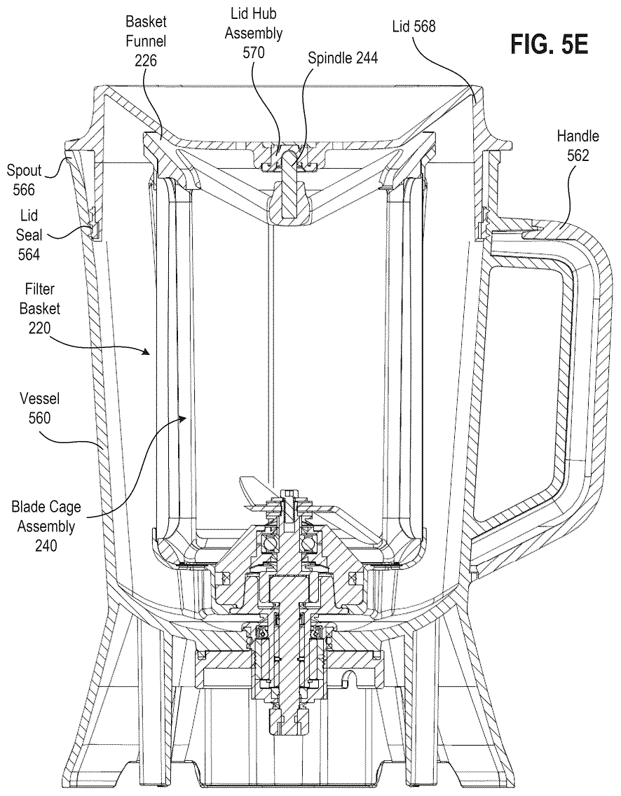

FIG. 5A illustrates a cutaway view of the vessel 200, in accordance with at least one embodiment. A basket drive assembly 410 is coupled to the bottom portion of the vessel body, and includes a basket drive coupling 412 configured to couple to and drive rotation of the filter basket 220 and blade cage assembly 240. The basket drive assembly 410 further includes an upper drive shaft 414 configured to couple to and drive rotation of the drive shaft 262 in the opposite direction as the filter basket 220 and blade cage assembly 240. In at least one embodiment, the basket drive assembly 410 is scaled to the vessel body 202 by a retaining plate 416. A lower drive shaft 418 is configured to engage a motor drive system 550 of the power base 500, as described in greater detail below.

FIG. 5B illustrates an exploded view of the basket drive assembly 410, in accordance with at least one embodiment. As shown, the basket drive assembly 410 includes a seal 420A between the basket drive coupling 412 and an engaging portion of the upper drive shaft 414, as well as a seal 422 between the basket drive coupling 412 and a jug bearing housing 428. As shown, additional seals 438 and 420B are included in the basket drive assembly 410 and encompassed by a seal holder 442 that sits above a jug bearing sleeve 444. In at least one embodiment, the basket drive assembly 410 includes two one-way roller bearings 432 and 436 and a needle roller bearing 440, each separated from each other by spacers 434. A cutaway view of the basket drive assembly 410 is shown in FIG. 5C to illustrate the locations of the one-way roller bearings 432 and 436 in relation to the jug bearing sleeve 444. Bearing retainer O-rings 446 and 448 are disposed between the retaining plate 416 and the lower portion of the vessel body 202 when the retaining plate 416 is coupled thereto.

In at least one embodiment, the nozzle assembly 400 comprises a nozzle cover 402, which may further comprise a sensor element 403 (e.g., a magnet) that is detectable by a sensor of the power base 500 (e.g., a Hall effect sensor). For example, when the vessel is engaged to the power base 500, a sensor may be present within the power base 500 such that it is in relative proximity to the sensor element 403, and can be used to determine when the sensor element 403 is detectable (i.e., the nozzle cover 402 is closed) or undetectable (i.e., the nozzle cover 402 is open).

FIG. 5D illustrates a cutaway view of the vessel 200 illustrating the blade cage assembly 240 nested within the filter basket 220, and inserted within the vessel body 202, with the lid 300 and nozzle assembly 400 in a closed state, in accordance with at least one embodiment.

FIG. 5E illustrates a cutaway view of an alternative vessel 560, in accordance with at least one embodiment. The blade cage assembly 240 and filter basket 220 may fit within the vessel 560 as with the vessel 200. A lid 568 may fit within an upper portion of the vessel 560 and form a seal with the vessel 560 via a lid seal 564. In at least one embodiment the lid 568 aligns with the basket funnel 226, and comprises a lid hub assembly 570 configured to receive the spindle 244 from the blade cage assembly 240. In at least one embodiment, the vessel 560 includes a handle 562 to facilitate lifting the vessel 560 in and out of engagement with the motor drive system 550. Upon completion of the first stage operation (blending), and before commencement of the second stage operation (centrifugation), the user may remove the lid 568 from the vessel 560 to evacuate the processed contents into an externally positioned receiving vessel via a pouring spout 566. For separation of larger sized particles during pouring, a maximum liquid fill level of the vessel may be implemented by preventing liquid from exceeding the upper opening of the filter basket 220. Preferably, the upper opening of the filter basket 220 is also positioned above the pouring spout 566 of the vessel 560 and offset from the lid 568, further limiting the ability of particles larger than the filter mesh body 222 opening size to escape, both during pouring and processing of ingredients. In at least one embodiment, a plurality of holes may be present within the lid 568 to impart pressure equalization for improved pouring when the user pours out the contents of the vessel 560 via the spout 566.

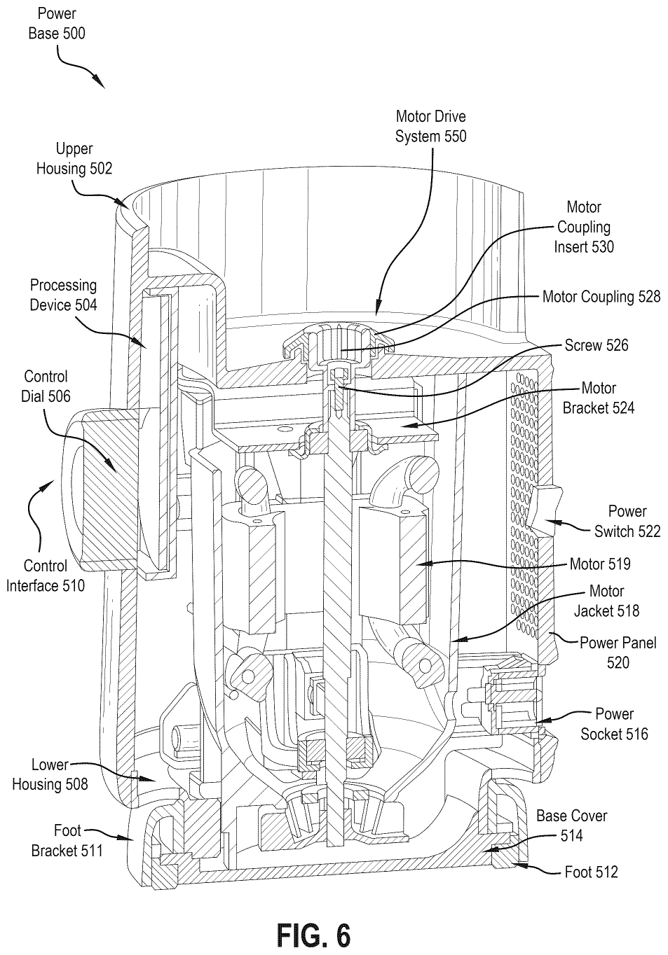

FIG. 6 illustrates a cutaway view of the power base 500, in accordance with at least one embodiment. The power base 500 includes an upper housing 502 coupled to a lower housing 508 and a base cover 514. In at least one embodiment, the upper housing 502 is configured to receive and secure the vessel 200, and to allow the mechanical components of the vessel 200 to engage the motor drive system 550 when the vessel 200 is secured therein. A foot 512 is coupled to the lower housing 508 via a foot bracket 511. In at least one embodiment, the foot 512 may be formed from a rubber material to resist sliding of the power base 500 along a surface upon which it sits during use. In at least one embodiment, the base cover 514, the foot 512, or both may comprise one or more load cells that are operatively coupled to the processing device 504 for detecting changes in mass during evacuation of liquid from the vessel 200.

In at least one embodiment, the control interface 510 is built into the upper housing 502. The control interface 510 may include, in certain embodiments, a processing device 504 that includes a built-in display device. In at least one embodiments, the display device may include a liquid crystal display, a light-emitting diode (LED) array display, a touchscreen display, or another suitable display device. For example, in certain embodiments, the control interface 510 includes a control dial 506 that the user may rotate to select operational parameters or modes, such as a processing recipe, which may be displayed in real-time by the display of the processing device 504. In at least one embodiment, the control dial 506 may be configured to allow a user to translationally actuate the dial as a form of input. In at least one embodiment, the control dial 506 may be replaced by one or more buttons or other types of input devices. In other embodiments, the control dial 506 or similar actuatable component may be omitted entirely, for example, if the control interface 510 includes a touchscreen display.

In at least one embodiment, a time of operation is displayed on the display when the selected operation mode is initiated. In at least one embodiment, an operation mode selected by the user, for example with the control dial 506, may correspond to one of a plurality of options for selecting a plant-based product, wherein each of the options is associated with a blending time duration, a centrifuging time duration, a blending speed, and a centrifuging speed. In at least one embodiment, one or more of these options may be selected and specified independently by the user. In at least one embodiment, some of these options may be pre-determined, for example, as part of a selectable recipe.

In at least one embodiment, the processing device 504 may be a generic computing machine that comprises a set of instructions for causing the machine to perform any one or more of the methodologies discussed herein when executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. Further, while only a single machine is illustrated, the term “machine” shall also be taken to include any collection of machines (e.g., computers) that individually or jointly execute a set (or multiple sets) of instructions to perform any one or more of the methodologies discussed herein. In at least one embodiment, the processing device 504 includes a main memory (e.g., read-only memory (ROM), flash memory, dynamic random access memory (DRAM) such as synchronous DRAM (SDRAM), etc.), a static memory (e.g., flash memory, static random access memory (SRAM), etc.), and/or a secondary memory.

The processing device 504 may be representative of one or more general-purpose processors such as a microprocessor, central processing unit, or the like. More particularly, the processing device 504 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 504 may also be one or more special-purpose processing devices such as an application specific integrated circuit (ASIC), a field programmable gate array (FPGA), a digital signal processor (DSP), network processor, or the like. The processing device 504 is configured to execute the processing logic for performing operations and steps discussed herein.

In at least one embodiment, the processing device 504 may comprise or be communicatively coupled to a computer-readable storage medium, which may store a software library containing executable instructions for operating the apparatus 100. The term “computer-readable storage medium” should be taken to include a single medium or multiple media (e.g., a centralized or distributed database, and/or associated caches and servers) that store the one or more sets of instructions. The term “computer-readable storage medium” shall also be taken to include any non-transitory medium (e.g., a medium other than a carrier wave) that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

In at least one embodiment, the power base 500 further includes a power panel 520 that includes a manual power switch 522 for supplying power to the power base 500 (including the processing device 504 and the motor 519), and a power socket 516 for receiving a plug connected to an alternating current or direct current power source.

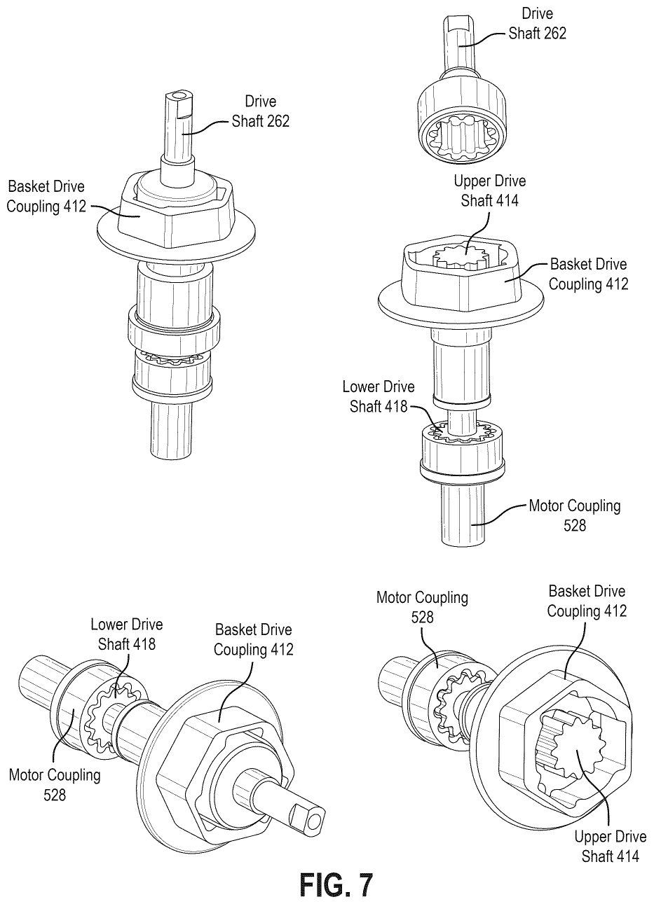

In at least one embodiment, the motor 519 is housed within a motor jacket 518 and is secured to the upper housing via a motor bracket 524. In at least one embodiment, the motor 519 is bi-directional motor configured to drive the motor drive system 550. For example, the motor drive system 550 includes a motor coupling 528 that is secured to a drive shaft of the motor via a screw 526, and is surrounding by a motor coupling insert that stabilizes the motor coupling 528 in the upper housing 502. In at least one embodiment, the motor coupling 528 is configured to couple to and drive the lower drive shaft 418 shown in FIG. 5A. FIG. 7 illustrates the coupling of various drive components described previously, in accordance with at least one embodiment. In at least one embodiment, the basket drive assembly 410 may comprise a one-way bearing assembly that allows for the independent rotation of the filter basket 220 and the blade 252 in opposite directions when coupled to a bi-directional motor drive system 550.

Under some circumstances, food may become captive and immovable during homogenisation, or distributed inconsistently onto the inner surfaces of the filter mesh body 222 during centrifugation. This may cause excessive vibration of the apparatus 100 during operation. In at least one embodiment, the apparatus may comprise one or more sensors in communication with the processing device 504 to detect an imbalance within the apparatus 100 during operation. For example, after detecting the imbalance via the one or more sensors, the processing device 504 may disable the motor 519 and enter a standby state. The control interface 510 may then provide an indication to the user that an error condition has occurred.

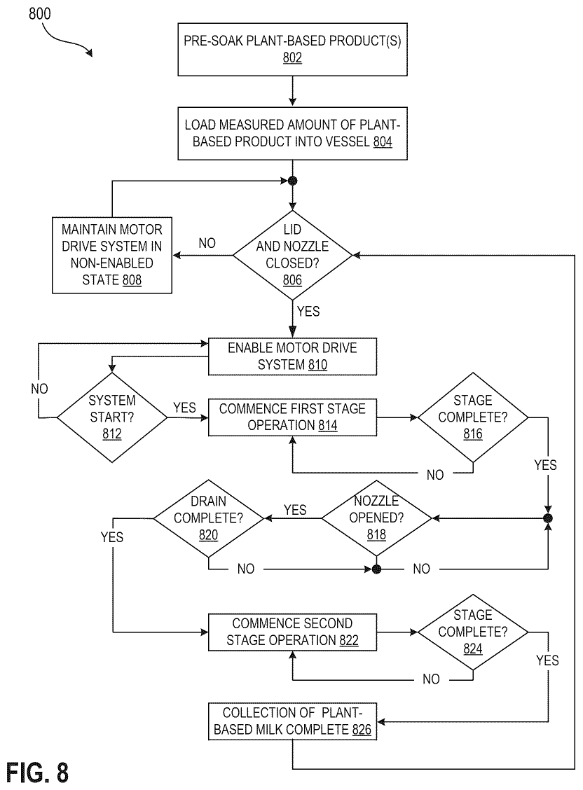

FIG. 8 illustrates a flow diagram for an exemplary method 800 of operating a centrifugal homogenization apparatus, in accordance with at least one embodiment. The method 800 is represented in block form, and one or more of the blocks may represent various actions or operations. Some of these actions or operations may be performed by a user, or may be automated using various automation techniques as would be appreciated by those of ordinary skill in the art. Moreover, some of these actions or operations may be performed under the control of processing logic that comprises hardware (e.g., circuitry, dedicated logic, programmable logic, microcode, etc.), software (such as instructions run on a processing device), or a combination thereof. For example, in at least one embodiment, processing logic corresponds to the processing device 504 of the power base 500. It is to be understood that the actions or operations described are merely exemplary, and some may omitted, combined with others, or performed in various orders with respect to each other.

At block 802, plant-based products are pre-soaked in water prior to processing or loading into a vessel of the apparatus (e.g., the vessel 200). The plant-based product may be selected from, but not limited to, almonds, hazelnuts, cashews, flaxseeds, walnuts, tiger nuts, quinoa, chia seeds, macadamia nuts, soy beans, oats, rice, coconut, potatoes, hemp seeds, peas, or a combination thereof. In at least one embodiment, the plant-based products are pre-soaked within the vessel.

At block 804, measured amount of plant-based product is loaded into the vessel, for example, by the user. The measured amount may correspond to an amount of plant-based product suggested for a particular recipe. In at least one embodiment, blocks 802 and 804 are combined. In at least one embodiment, a measured amount of liquid, such as water, may also be loaded into the vessel together with the plant-based product.

At block 806, a determination is made as to whether both a lid (e.g., the lid 300) and a nozzle (e.g., the nozzle cover 402 of the nozzle assembly 400) of the apparatus are in a closed state to enable a motor drive system of the apparatus (e.g., the motor drive system 550). For example, one or more Hall effect sensors may be present on each of the lid and/or within the nozzle assembly, for which a processing device (e.g., the processing device 504) may utilize to detect the state of these components. Responsive to a determination that one or more of the lid or the nozzle is in an open state, the method 800 proceeds to block 808 where the processing device maintains the motor drive system in a non-enabled state to prevent any processing operations. Otherwise, the method 800 proceeds to block 810, where the motor drive system is enabled. In at least one embodiment, the lid may utilize a micro-switch configuration that conveys to the processing device whether the lid is in the closed or open state depending on the state of the microswitch.

At block 812, a determination is made as to whether the first stage operation is to start. For example, in at least one embodiment, the apparatus may remain in an idle state until a user input is received at the control interface 510 (e.g., the control interface 510) indicating that the user wishes to commence the processing.

Responsive to determining that the first stage operation is to start, the method 800 then proceeds to block 814, where the first stage operation is initiated to engage the motor drive system and blend the plant-based product in the vessel. In at least one embodiment, the first stage operation is a blend operation to blend the plant-based product within the vessel. In at least one embodiment, the first stage operation continues until a determination is made at block 816 that the first stage operation is complete. For example, the determination may be in response to a fixed time duration has elapsed (e.g., about 10 seconds to about 120 seconds), or in response to a user input to interrupt the first stage operation. In at least one embodiment, the fixed time duration, a blend rotation speed, and/or other blend parameters may be specified by a recipe selected by or inputted by the user via the control interface.

After the first stage operation is complete (i.e., blending is halted), the method 800 then proceeds to block 818, where a determination is made as to whether the nozzle is in an open state (e.g., based on a Hall effect sensor present in the nozzle). If the nozzle is determined to be in the open state, the method 800 then proceeds to block 820, where a determination is made as to whether the vessel has been sufficiently free of liquid by draining through the nozzle. In at least one embodiment, determining that the vessel is substantially free of liquid may include detecting, via a sensor disposed within the nozzle assembly (e.g., a Hall effect sensory), that the nozzle assembly is in an open state for a fixed duration, which would provide sufficient time for the liquid to drain from the nozzle (e.g., 5 to 10 seconds). In at least one embodiment, determining that the vessel is substantially free of liquid may include receiving a user confirmation via a control interface of the apparatus. In at least one embodiment, determining that the vessel is substantially free of liquid comprises detecting, after expiration of the first time duration, that a mass contained in the vessel has decreased below a mass threshold (e.g., based on one or more load cells disposed on a supporting portion of the power base and operatively coupled to the processing device). In at least one embodiment, the nozzle may comprise an actuatable component that is under control of the processing device that allows the processing device to automatically cause the nozzle to open.

If at either block 818 or block 820 a determination is made that the nozzle is in the open state or the vessel is not sufficiently empty, respectively, the method proceeds back to 818 such that the second stage operation is not performed until these conditions are both met.

After the conditions of blocks 818 and 820 are satisfied, the method 800 proceeds to block 822 where the second stage operation is initiated to engage the motor drive system and centrifuge the processed contents within the vessel. In at least one embodiment, the processing device prevents the second stage operation from being performed unless the nozzle is in an open state. In at least one embodiment, the second stage operation continues until a determination is made at block 824 that the second stage operation is complete. For example, the determination may be in response to a fixed time duration has elapsed (e.g., about 10 seconds to about 120 seconds), or in response to a user input to interrupt the second stage operation. In at least one embodiment, the fixed time duration, a centrifugal rotation speed, and/or other parameters may be specified by a recipe selected by or inputted by the user via the control interface.

Once the second stage operation is complete, the method 800 proceeds to block 826, where the collection of plant-based milk is determined to be complete. In at least one embodiment, the apparatus may automatically shut down upon the method 800 reaching block 826. In at least one embodiment, the method 800 proceeds from block 826 to block 806.

The following paragraphs describe exemplary Embodiments that, alone or in combination with various embodiments described herein, and/or with modifications that would be within the purview of those or ordinary skill in the art, may serve as the basis for subject matter to be claimed.

Embodiment 1: A method of operating a centrifugal homogenization apparatus, the method comprising: causing the apparatus to perform a first stage operation to blend a plant-based product together with a liquid within a single vessel for a first time duration; and responsive to determining that the vessel is substantially free of liquid, causing the apparatus to perform a second stage operation to centrifuge residual plant-based product within the vessel for a second time duration.

Embodiment 2: The method of Embodiment 1, wherein causing the apparatus to perform the first stage operation occurs responsive to determining that a lid and a nozzle assembly of the apparatus are in a closed state.

Embodiment 3: The method of Embodiment 2, wherein determining that the vessel is substantially free of liquid comprises detecting a sensor element disposed within the nozzle assembly to determine that the nozzle assembly is in an open state for a third time duration after the first time duration has expired.

Embodiment 4: The method of Embodiment 3, further comprising: causing the nozzle assembly to open to drain the vessel of the liquid after expiration of the first time duration.

Embodiment 5: The method of either Embodiment 3 or 4, wherein the sensor element comprises a Hall effect sensor.

Embodiment 6: The method of any one of the preceding Embodiments, wherein the first stage operation is associated with rotation in a first direction, and wherein the second stage operation is associated with rotation in a second direction, the second direction opposed to the first direction.

Embodiment 7: The method of any one of the preceding Embodiments, wherein determining that the vessel is substantially free of liquid comprises receiving a user confirmation via a control interface of the apparatus.

Embodiment 8: The method of any one of the preceding Embodiments, wherein determining that the vessel is substantially free of liquid comprises detecting, after expiration of the first time duration, that a mass contained in the vessel has decreased below a mass threshold.

Embodiment 9: A method of extracting a liquid substance from a plant-based product, the method comprising: loading a measured amount of the plant-based product into a vessel of a centrifugal homogenization apparatus; determining that both a lid and a nozzle of the apparatus are in a closed state to enable a motor drive system of the apparatus; responsive to the determination, initiating a first stage operation, the first stage operation engaging the motor drive system to blend the plant-based product in the vessel for a first time duration; evacuating liquid from the vessel; subsequently initiating a second stage operation, the second stage operation engaging the motor drive system to centrifuge residual plant-based product in the vessel for a second time duration; and completing collection of the liquid from the centrifuged residual plant-based product.

Embodiment 10: The method of Embodiment 9, wherein the liquid is evacuated when the nozzle of the apparatus is opened after completion of the first stage operation.

Embodiment 11: The method of either Embodiment 9 or 10, wherein the liquid is evacuated into an accessory container positioned at the nozzle opening.

Embodiment 12: The method of any one of Embodiments 9-11, wherein the motor drive system is configured to independently control rotation of a blender blade during the first stage operation and counter-rotation of a filter mesh during the second stage operation.

Embodiment 13: The method of any one of Embodiments 9-12, wherein each of the first time duration and the second time duration is from about 10 seconds to about 120 seconds.

Embodiment 14: The method of any one of Embodiments 9-13, wherein the plant-based product is selected from almonds, hazelnuts, cashews, flaxseeds, walnuts, tiger nuts, quinoa, chia seeds, macadamia nuts, soy beans, oats, rice, coconut, potatoes, hemp seeds, peas, or a combination thereof.

Embodiment 15: A centrifugal homogenization apparatus configured to perform the method of any one of the preceding Embodiments.

Embodiment 16: A centrifugal homogenization apparatus comprising: a power base comprising a motor drive system, a control interface, and a processing device operatively coupled to the motor drive system and the control interface; a vessel coupled to the power base for receiving a plant-based product, the vessel comprising a lid, a filter basket, a blade cage assembly, and a nozzle assembly adapted for evacuation of liquid from the vessel; and an interlock system configured to determine an open state and closed state for each of the lid and the nozzle assembly.

Embodiment 17: The apparatus of Embodiment 16, wherein the control interface comprises an actuatable control for operating the power base and a display device, wherein the actuatable control allows for selection of an operation mode, and wherein the display device is configured to display the selected operation mode.

Embodiment 18: The apparatus of Embodiment 17, wherein a time of operation is displayed on the display device when the selected operation mode is initiated.

Embodiment 19: The apparatus of either Embodiment 17 or 18, wherein the operation mode corresponds to one of a plurality of options for selecting a plant-based product, wherein each of the options is associated with a blending time duration, a centrifuging time duration, a blending speed, and a centrifuging speed.

Embodiment 20: The apparatus of any one of Embodiments 16-19, wherein the lid comprises a bayonet-style coupling to the vessel.

Embodiment 21: The apparatus of any one of Embodiments 16-20, wherein the lid comprises a hinged-style coupling to the vessel.

Embodiment 22: The apparatus of any one of Embodiments 16-21, wherein the interlock system is provided via one or more Hall effect sensors integrated into one or more of the lid or the nozzle assembly.

Embodiment 23: The apparatus of any one of Embodiments 16-22, further comprising at least one load cell disposed on a supporting portion of the power base and operatively coupled to the processing device, wherein the processing device is configured to monitor a mass of contents contained in the vessel.

Embodiment 24: An assembly for insertion into a vessel of a centrifugal homogenization apparatus, the assembly comprising: a blade cage assembly comprising a funneled upper portion connected to a lower base portion via a plurality of ribs disposed around an outer periphery, and a blender blade rotatably coupled to the lower base portion; and a filter basket comprising a filter mesh body and a basket base, wherein the blade cage assembly is nested within the filter basket such that the lower base portion is seated in the basket base.

Embodiment 25: The assembly of Embodiment 24, wherein the plurality of ribs arc configured to agitate contents of the vessel during operation of the centrifugal homogenization apparatus.

Embodiment 26: The assembly of either Embodiment 24 or 25, wherein the plurality of ribs are configured for use as scrapers to dislodge pulp accumulated along an interior surface of the filter basket during removal of the blade cage assembly from the filter basket.

Embodiment 27: The assembly of any one of Embodiments 24-26, wherein the plurality of ribs are constructed such that the plurality of ribs cause the outer diameter of blade cage assembly to be greater than the inner diameter of the filter mesh body at locations where the plurality of ribs contact the filter mesh body such that the plurality of ribs fit tightly against an interior surface of the filter mesh body and prevent slippage between the blade cage assembly and the filter basket during operation of the centrifugal homogenization apparatus.

Embodiment 28: The assembly of any one of Embodiments 24-27, wherein the filter mesh body comprises mesh openings of about 0.1 mm to about 0.3 mm in diameter.

Embodiment 29: The assembly of any one of Embodiments 24-28, wherein the lower base portion comprises a plurality of openings covered by a lower filter mesh to facilitate liquid circulation and improved mixing during operation of the centrifugal homogenization apparatus.

Embodiment 20: The assembly of any one of Embodiments 24-29, wherein the funneled upper portion comprises a central spindle extending distally therefrom, and wherein the central spindle is configured to engage with a lid of the vessel.

Embodiment 31: The assembly of any one of Embodiments 24-30, wherein the vessel further comprises a one-way bearing assembly configured to enable independent rotation of the filter basket and the blender blade in opposite directions when coupled to a motor drive system of the centrifugal homogenization apparatus.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “certain embodiments,” “one embodiment,” “at least one embodiment,” or the like means that a particular feature, structure, or characteristic described in connection with the embodiment is included in at least one embodiment. Thus, the appearances of the phrase “certain embodiments,” “one embodiment,” “at least one embodiment,” or the like in various places throughout this specification are not necessarily all referring to the same embodiment.

The present disclosure is not to be limited in scope by the specific embodiments described herein. Indeed, other various embodiments of and modifications to the present disclosure, in addition to those described herein, will be apparent to those of ordinary skill in the art from the description and accompanying drawings. Thus, such other embodiments and modifications are intended to fall within the scope of the present disclosure. Further, while the present disclosure has been described in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A method of operating a centrifugal homogenization apparatus, the method comprising:
causing the apparatus to perform a first stage operation to blend a plant-based product together with a liquid within a single vessel for a first time duration; and
responsive to determining that the vessel is substantially free of liquid, causing the apparatus to perform a second stage operation to centrifuge residual plant-based product within the vessel for a second time duration, wherein the first stage operation is associated with rotation in a first direction, and wherein the second stage operation is associated with rotation in a second direction, the second direction opposed to the first direction.

2. The method of claim 1, wherein causing the apparatus to perform the first stage operation occurs responsive to determining that a lid and a nozzle assembly of the apparatus are in a closed state.

3. The method of claim 2, wherein determining that the vessel is substantially free of liquid comprises detecting a sensor element disposed within the nozzle assembly to determine that the nozzle assembly is in an open state for a third time duration after the first time duration has expired.

4. The method of claim 3, further comprising:
causing the nozzle assembly to open to drain the vessel of the liquid after expiration of the first time duration.

5. The method of claim 3, wherein the sensor element comprises a Hall effect sensor.

6. The method of claim 1, wherein determining that the vessel is substantially free of liquid comprises receiving a user confirmation via a control interface of the apparatus.

7. The method of claim 1, wherein determining that the vessel is substantially free of liquid comprises detecting, after expiration of the first time duration, that a mass contained in the vessel has decreased below a mass threshold.

8. A method of extracting a liquid substance from a plant-based product, the method comprising:
loading a measured amount of the plant-based product into a vessel of a centrifugal homogenization apparatus;
determining that both a lid and a nozzle of the apparatus are in a closed state to enable a motor drive system of the apparatus;
responsive to the determination, initiating a first stage operation, the first stage operation engaging the motor drive system to blend the plant-based product in the vessel for a first time duration, wherein the motor drive system is configured to control rotation of a blender blade during the first stage operation;
evacuating liquid from the vessel;
subsequently initiating a second stage operation, the second stage operation engaging the motor drive system to centrifuge residual plant-based product in the vessel for a second time duration, wherein the motor drive system is configured to independently control counter-rotation of a filter mesh during the second stage operation; and
completing collection of the liquid from the centrifuged residual plant-based product.

9. The method of claim 8, wherein the liquid is evacuated when the nozzle of the apparatus is opened after completion of the first stage operation.

10. The method of claim 8, wherein the liquid is evacuated into an accessory container positioned at the nozzle opening.

11. The method of claim 8, wherein each of the first time duration and the second time duration is from about 10 seconds to about 120 seconds.

12. The method of claim 8, wherein the plant-based product is selected from almonds, hazelnuts, cashews, flaxseeds, walnuts, tiger nuts, quinoa, chia seeds, macadamia nuts, soy beans, oats, rice, coconut, potatoes, hemp seeds, peas, or a combination thereof.

13. A centrifugal homogenization apparatus comprising:
a power base comprising a motor drive system, a control interface, and a processing device operatively coupled to the motor drive system and the control interface;
a vessel coupled to the power base for receiving a plant-based product, the vessel comprising a lid, a filter basket, a blade cage assembly comprising a blender blade, and a nozzle assembly adapted for evacuation of liquid from the vessel, wherein the motor drive system is configured to independently drive rotation of the blender blade in a first direction in a first stage of operation and the filter basket in a second direction opposite the first direction in a second stage of operation; and
an interlock system configured to determine an open state and closed state for each of the lid and the nozzle assembly.

14. The apparatus of claim 13, wherein the control interface comprises an actuatable control for operating the power base and a display device, wherein the actuatable control allows for selection of an operation mode, and wherein the display device is configured to display the selected operation mode.

15. The apparatus of claim 14, wherein a time of operation is displayed on the display device when the selected operation mode is initiated.

16. The apparatus of claim 14, wherein the operation mode corresponds to one of a plurality of options for selecting a plant-based product, wherein each of the options is associated with a blending time duration, a centrifuging time duration, a blending speed, and a centrifuging speed.

17. The apparatus of claim 13, wherein the lid comprises a bayonet-style coupling to the vessel.

18. The apparatus of claim 13, wherein the lid comprises a hinged-style coupling to the vessel.

19. The apparatus of claim 13, wherein the interlock system is provided via one or more Hall effect sensors integrated into one or more of the lid or the nozzle assembly.

20. The apparatus of claim 13, further comprising at least one load cell disposed on a supporting portion of the power base and operatively coupled to the processing device, wherein the processing device is configured to monitor a mass of contents contained in the vessel.
